(19) United States
(12) Patent Application Publication
(10) Pub. No.: US 2026/0071142 A1
(43) Pub. Date: Mar. 12, 2026

(54) LAUNDRY DETERGENT COMPOSITIONS

(71) Applicant: THE PROCTER & GAMBLE COMPANY, Cincinnati, OH (US)

(72) Inventors: Randall Thomas REILMAN, Cincinnati, OH (US); William Coffin SHEAROUSE, Cincinnati, OH (US); Phillip Kyle VINSON, Fairfield, OH (US); John August WOS, Mason, OH (US)

(21) Appl. No.: 19/317,376

(22) Filed: Sep. 3, 2025

(30) Foreign Application Priority Data
Sep. 6, 2024 (EP) 24198899.7
Mar. 21, 2025 (EP) 25165209.5

(51) Int. Cl. C11D 1/37; C11D 1/14; C11D 1/22; C11D 1/29

(52) U.S. Cl. CPC C11D 1/37; C11D 1/146; C11D 1/22; C11D 1/29

(57) ABSTRACT

The need for liquid laundry detergent compositions which comprise very low levels or even no dioxane, while also providing improved removal of sebum and other stains, is met by formulating the detergent composition using alkyl glycol sulfate anionic surfactant having a high fraction of the alkyl glycol sulfate anionic surfactant with a longer alkyl chain length.

### FIELD OF THE INVENTION

Liquid laundry detergent compositions.

### BACKGROUND OF THE INVENTION

Fabric detergent compositions are typically formulated using a surfactant system which comprises anionic surfactant, typically a combination of alkyl ether sulfate surfactant and sulfonate surfactant.

Alkyl ethoxylated sulfate anionic surfactants have typically been formed via the reaction of alkyl alcohols with an ethylene oxide, which gives rise to a broad distribution of degree of ethoxylation. However, sulfation processes to make such alkyl ether sulfate anionic surfactants may result in trace residual amounts of 1,4-dioxane by-product being present, with the amount of dioxane formed being at least in part related to the proportion of alkyl ethoxylated sulfate anionic surfactant comprising two or more ethoxy groups. The amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. An alternative is to use alkyl sulfate anionic surfactants which are free of ethoxylation. However, formulating with such alkyl sulfate anionic surfactants in place of alkyl ether sulfate anionic surfactant can be detrimental to cleaning performance, low temperature stability, or both. As an alternative, processes are known whereby instead of ethoxylating an alkyl alcohol, an ethylene glycol monomer or oligomer is reacted with an alkene, before sulfation. Since the resultant sulfate surfactant is not formed using an ethoxylation step, it is technically incorrect to refer to them as alkyl ethoxylated surfactants. As such, and since they are typically formed by reacting an alkene with glycol (aliphatic diol), they will be referred to as alkyl glycol sulfate anionic surfactants, for example alkyl ethylene glycol sulfate (AEGS).

Such processes, for example as described in WO202464645A, result in a much narrower distribution of the glycol groups in the resultant alkyl glycol sulfate anionic surfactants, and hence enable significant reductions in the presence and formation of dioxanes within the detergent formulae containing them. However, it has been found that such surfactants, due to their structure, are typically less effective at removing a variety of stains and particularly sebum stains. Sebum is an oily substance that is secreted by the sebaceous glands to hydrate the skin and form a protective layer. Sebum stains are readily discernable on many fabrics, especially as they also readily retain particulate soils. As such, even small reductions in the cleaning efficacy of sebum stains during laundering processes are quickly noticed by users of fabric detergent compositions. As such, there remains a need to improve stain removal, and especially sebum stain removal, for fabric detergent compositions which comprise a combination of alkyl glycol sulfate anionic surfactant and sulfonate anionic surfactant.

US20220324781A relates to a higher secondary alcohol alkoxylate precursor obtained by reacting a long-chain olefin with a (poly)alkylene glycol. WO202464645A relates to a process including the steps of contacting an olefin, an alcohol and a metallosilicate catalyst to form oligomers of an alcohol “ethoxylate”; and sulfating the oligomers. WO202463991A relates to aqueous laundry detergent compositions comprising such surfactants. WO2024063990A relates to aqueous light duty liquid detergent formulation comprising such surfactants. JP2006137872A relates to a powdery detergent composition having good fluidity, detergency and rinsing property, having little odor and excellent in disperse solubility even to low-temperature water, the powdery detergent composition comprising a higher secondary alcohol alkoxylate sulfate salt and an anionic surfactant other than the higher secondary alcohol alkoxylate sulfate salt.

### SUMMARY OF THE INVENTION

The present invention relates to a liquid laundry detergent composition comprising from 2.5% to 60% by weight of the detergent composition of a surfactant system, wherein the surfactant system comprises: anionic surfactant, wherein the anionic surfactant comprises sulfonate anionic surfactant and an alkyl glycol sulfate anionic surfactant, wherein alkyl glycol sulfate anionic surfactant has the formula (I): R1CH(R2)(OCH₂CH₂)ₙOSO₃⁻M⁺ (I) wherein: R1 is independently H, alkyl, alkylene, or a mixture thereof; R2 is independently alkyl, alkylene, or a mixture thereof; the sum of the carbon atoms present in R1 and R2 is on average from 11 to 17; n is from 1 to 3, wherein 90 mol % or greater of the surfactant molecules of structure (I) have an n of 1 and 10 mol % or less of the surfactant molecules of structure (I) have an n of 2 or greater; and M+ is a counterion, characterized in that: the weight ratio of the alkyl glycol sulfate anionic surfactant of formula (I) in which sum of the carbon atoms present in R1 and R2 is 15 or higher to the total alkyl glycol sulfate anionic surfactant of formula (I) is 25% or higher.

### DETAILED DESCRIPTION OF THE INVENTION

The detergent compositions of the present invention have been found to result in further reduction in 1,4-dioxane levels while also providing improved cleaning, especially of sebum stains.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

All measurements are performed at 25° C. unless otherwise specified.

As used herein, the articles including “a” and “an” when used in a claim, are understood to mean one or more of what is claimed or described.

### Laundry Detergent Composition

The laundry detergent composition is a liquid.

As used herein, “liquid detergent composition” refers to liquid detergent composition, which is fluid, and preferably capable of wetting and cleaning a fabric, e.g., clothing in a domestic washing machine. As used herein, “laundry detergent composition” refers to compositions suitable for washing clothes. The composition can include solids or gases in suitably subdivided form, but the overall composition excludes product forms which are non-fluid overall, such as tablets or granules. The liquid laundry detergent composition preferably has a density in the range from 0.9 to 1.3 grams per cubic centimetre, more specifically from 1.00 to 1.10 grams per cubic centimetre, excluding any solid additives but including any bubbles, if present.

The composition can be an aqueous liquid laundry detergent composition. For such aqueous liquid laundry detergent compositions, the water content can be present at a level of from 5.0% to 95%, preferably from 25% to 90%, more preferably from 50% to 85% by weight of the liquid detergent composition.

The pH range of the detergent composition is from 6.0 to 8.9, preferably from pH 7 to 8.8.

### Surfactant System

The laundry composition comprises the surfactant system at a level of from 2.5% to 60%, preferably from 5.0% to 25%, more preferably from 7.0% to 15% by weight of the composition.

Suitable surfactants as used herein means surfactants or mixtures of surfactants that provide cleaning, stain removing, or laundering benefit to soiled material. Suitable detersive surfactants include anionic surfactants and can further comprise nonionic surfactant, zwitterionic surfactant, and combinations thereof.

The anionic surfactant comprises a combination of alkyl glycol sulfate anionic surfactant and sulfonate anionic surfactant.

### Anionic Surfactant

The surfactant system comprises anionic surfactant. The anionic surfactant can be at a level of from 1.4% to 52%, preferably from 4.4% to 20%, more preferably from 5.9% to 11.5% of the liquid laundry detergent composition.

The sulfonate anionic surfactant is present at a level of at least 40%, preferably from 40% to 90%, more preferably from 50% to 70% by weight of the surfactant system. The sulfonate anionic surfactant can be present at a level of at least 55%, preferably from 60% to 90%, more preferably from 70% to 85% by weight of the anionic surfactant.

A combination of linear alkyl benzene sulfonate and alkyl sulfate surfactant is particularly preferred, especially for improving stain removal. As such, the anionic surfactant preferably comprises sulfonate anionic surfactant and alkyl sulfate anionic surfactant, preferably wherein the sulfonate anionic surfactant and alkyl sulfate anionic surfactant are present in a weight ratio of from 55:45 to 99:1, more preferably from 60:40 to 95:5, and most preferably from 70:30 to 85:15. The liquid laundry detergent composition preferably comprises the sulfonate anionic surfactant and alkyl sulfate anionic surfactant at a level of at least 50%, preferably at least 70%, more preferably at least 90% by weight of the anionic surfactant.

### Alkyl Glycol Sulfate Anionic Surfactant

The anionic surfactant comprises alkyl glycol sulfate anionic surfactant.

The alkyl glycol sulfate anionic surfactant can be present at a level of from 1.0% to 15%, preferably from 2.5% to 10%, more preferably from 3.5% to 8.0% of the composition. Preferably the alkyl glycol sulfate anionic surfactant is present at a level of from 10.0% to 50% preferably from 15% to 40%, more preferably from 20% to 35% by weight of the anionic surfactant system, wherein the total anionic surfactant adds up to 100%.

The alkyl glycol sulfate anionic surfactant has the formula (I):

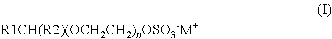

The value of n in structure (I) has a value from 1 to 3. For example, n may be 1, 2, or 3. 90 mol % or greater of the surfactant molecules of structure (I) have an n of 1 and 10 mol % or less of the surfactant molecules of structure (I) have an n of 2 or greater. More preferably, 92 mol % or greater of the surfactant molecules of structure (I) have an n of 1 and 8 mol % or less of the surfactant molecules of structure (I) have an n of 2 or greater. Most preferably, 95 mol % or greater of the surfactant molecules of structure (I) have an n of 1 and 5 mol % or less of the surfactant molecules of structure (I) have an n of 2 or greater.

In formula (I), the group (OCH₂CH₂)ₙ can be derived from ethylene glycol (ethane-1,2-diol) or oligomers of ethylene glycol, wherein the suitable oligomers of ethylene glycol comprise up to 3 monomer units of the ethylene glycol.

R1 is independently H, alkyl, alkylene, or a mixture thereof, preferably H, alkyl, or a mixture thereof, with a blend of H and alkyl being particularly preferred. Typically, the alkyl glycol sulfate anionic surfactant is a blend of alkyl glycol sulfate anionic surfactant of formula (I), in which R1 is H and alkyl, with the major part being alkyl glycol sulfate anionic surfactant of formula (I), in which R1 is alkyl, with a relatively minor part being alkyl glycol sulfate anionic surfactant of formula (I), in which R1 is H. This is because the alkyl glycol sulfate anionic surfactants of formula (I) are typically formed via an addition reaction which follows Markovnikov's rule, resulting in the most stable carbocation being formed on the more substituted carbon atom of the alkene bond due to induction and hyperconjugation. However, residual amounts of alkyl glycol sulfate anionic surfactant of formula (I) are formed in which R1 is H, since other less substituted, less stable carbocation are still formed as intermediates at some residual concentration. Preferably in at least 50% by weight, more preferably at least 60%, most preferably at least 80% by weight of the alkyl glycol sulfate of formula (I), R1 is alkyl, with the remainder being H. R1 preferably comprises from 1 to 6 carbon atoms, preferably from 1 to 3 carbon atoms. Preferably, in at least 80%, more preferably in at least 90% by mol of the alkyl glycol sulfate anionic surfactant of formula (I), R1 comprises 1 carbon atom, more preferably is methyl. As such, methyl branching at the C1 position is preferably present for at least 80%, or even at least 90% by mol of alkyl glycol sulfate anionic surfactant, wherein the C1 position is the carbon atom bound to the oxygen atom of the glycol sulfate group.

R2 is independently alkyl, alkylene, or a mixture thereof, preferably alkyl. R2 preferably comprises from 15 to 20 carbon atoms, preferably from 6 to 18 carbon atoms, more preferably from 8 to 16 carbon atoms.

The sum of the carbon atoms present in R1 and R2 is on average from 7 to 21, preferably from 9 to 19, more preferably from 11 to 17, most preferably 13 to 15.

For both R1 and R2, alkyl is preferred over alkylene as the presence of multiple double-bonds in the starting alkene can lead to reduced selectivity for the terminal double bond during the reaction to form the ether-bond. As such, while R1 and R2 can be independently saturated or unsaturated, saturated is preferred.

The distribution of R1 and R2 can be determined either analytically (for instance through ¹H NMR and/or ¹³C NMR) or can be determined from the starting materials used to make the alkyl glycol sulfate anionic surfactant.

When the weight ratio of alkyl glycol sulfate anionic surfactant of formula (I) in which sum of the carbon atoms present in R1 and R2 is 15 or higher to the total alkyl glycol sulfate anionic surfactant of formula (I) is 25% or higher, the laundry detergent composition has been found to provide improved cleaning, especially of sebum stains, in addition to a reduced 1,4-dioxane level. Preferably, the weight ratio of alkyl glycol sulfate anionic surfactant of formula (I) in which sum of the carbon atoms present in R1 and R2 is 15 or higher to the total alkyl glycol sulfate anionic surfactant of formula (I) is from 30% or higher, more preferably from 30% to 90%, most preferably from 40% to 70%.

The weight ratio of the alkyl glycol sulfate anionic surfactant of formula (I) to the sulfonate anionic surfactant is at least 25:75, or from 25:75 to 90:10, preferably from 30:60 to 80:20, more preferably 40:60 to 60:40.

M⁺ of structure (I) is a counterion, preferably M⁺ is an alkali metal counterion or ammonium, ethanolamine, isopropanolamine, triethylamine, triethanolamine, N-methyl diethanolamine, N,N-dimethyl ethanolamine, N,N-dimethyl propanolamine, and combinations thereof, more preferably Na⁺, K⁺, Mg²⁺, or ethanolamine, most preferably Na⁺. It will be understood that different surfactant molecules may have different materials for M+.

In formula (I), R1CH(R2) can be derived from suitable alkenes, especially linear alpha olefins (LAO). Linear alpha olefins are straight-chain terminal alkenes and hence comprise a double bond at the alpha (α-, 1- or primary) position, and a linear (unbranched) hydrocarbon chain. As such, they result in longer, less branched, alkyl groups in the resultant alkyl glycol sulfate anionic surfactant relative to when starting from mid-chain unsaturated alkenes. Suitable linear alpha olefins can be selected from the group consisting of: 1-dodecene, 1-tetradecene, 1-hexadecene, and mixtures thereof. Commercial sources of such alpha olefins can contain minor levels of other chain-length olefins, branched olefins, and vinylidene olefins.

Alternatively, branched olefins can be used. The chemical and physical properties of the resultant alkyl glycol sulfate anionic surfactant can vary with the choice of linear or branched olefin, and also with the degree and type of branching. Examples of suitable branched olefins include propylene tetramer (dodecene) (C12), as sold by Exxon.

Linear alpha olefins can be made using any known process, including via: the oligomerization of ethylene, Fischer-Tropsch synthesis, dehydration of alcohols, or thermal cracking of waxes. Alternatively, the olefin can be “bio-derived”, as described in WO2011002284A or Yu, H., Wang, C., Lin, T. et al. “Direct production of olefins from syngas with ultrahigh carbon efficiency”, Nat. Commun. 13, 5987 (2022). Alkyl glycol sulfate anionic surfactants are similar to alkyl ethoxylated sulfate anionic surfactants but have some key differences.

Ethoxylated sulfate anionic surfactants are typically formed by first ethoxylating an alkyl alcohol to add ethylene oxide (C₂H₄O) to the alkyl alcohol, using epoxides as a starting material. The resultant alkyl ethoxylated nonionic surfactant is then sulfated to form the alkyl ethoxylated sulfate anionic surfactant.

When forming the alkyl ethoxylated nonionic surfactant, some polymerisation of the ethylene oxides occurs which results in a relatively broad distribution of degree of ethoxylation of the alkyl alcohol. The ethylene oxide used to make ethoxylated surfactants, can also give rise to the formation of 1,4-dioxanes, especially where the molecules of the alkyl ethoxylated sulfate anionic surfactant comprise at least two EO groups. This is because the ethylene oxide must first dimerise to form 1,4-dioxane. With alkyl ethoxylated sulfate anionic surfactants, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof. However, it remains challenging to further reduce the dioxane level in alkyl ethoxylated surfactants.

Exemplary processes for making alkyl glycol sulfate s of use in the present invention are described in WO202464645A. In contrast to alkyl ethoxylated sulfate anionic surfactants, alkyl glycol sulfate anionic surfactants are typically formed via the acid-catalysed addition of the glycol which results in the Markovnikov addition of a hydrogen (typically on the less substituted side) and an alkoxy group, resulting in the addition of an ether-bond, followed by a reaction to add SO3, i.e., a sulfation process, and subsequent neutralization to provide a counterion.

This results in the alkyl glycol sulfate anionic surfactants comprising an extremely narrow distribution of ethylene glycol units in the alkyl glycol sulfate d anionic surfactant, typically from 1 to 3 ethylene glycol units per molecule of alkyl glycol sulfate anionic surfactant, or even 1 ethylene glycol unit per molecule of alkyl glycol sulfate anionic surfactant. The alkyl glycol sulfate anionic surfactant formed using such processes is also typically free of alkyl sulfate anionic surfactant that does not comprise the glycol linking group between the alkyl chain and the sulfate group.

When the alkyl glycol sulfate anionic surfactant is derived from the reaction of an alpha-olefin with the glycol, methyl branching at the C1 position can be present for at least 90%, or even at least 95% by mol of alkyl glycol sulfate anionic surfactant, wherein the C1 position is the carbon atom bound to the oxygen atom of the glycol sulfate group.

### Sulfonate Anionic Surfactant

The sulfonate anionic surfactant can be present can be present at a level of from 2.5% to 30%, preferably from 5.0% to 25%, more preferably from 7.5% to 20% by weight of the composition. Preferably the sulfonate anionic surfactant is present at a level of from 50.0% to 90% preferably from 60% to 85%, more preferably from 65% to 80% by weight of the anionic surfactant system, wherein the total anionic surfactant adds up to 100%.

The sulfonate anionic surfactant can be selected form the group consisting of: alkyl benzene sulfonates, alkyl ester sulfonates, paraffin sulfonates, alkyl sulfonated polycarboxylic acids, and mixtures thereof, preferably linear alkyl benzene sulfonate, more preferably C11-C13 alkyl benzene sulfonates.

Anionic sulfonate or sulfonic acid surfactants suitable for use herein include the acid and salt forms of alkylbenzene sulfonates, alkyl ester sulfonates, alkane sulfonates, alkyl sulfonated polycarboxylic acids, and mixtures thereof. Suitable anionic sulfonate or sulfonic acid surfactants include: C5-C20 alkylbenzene sulfonates, more preferably C10-C16 alkylbenzene sulfonates, more preferably C11-C13 alkylbenzene sulfonates, C5-C20 alkyl ester sulfonates, C6-C22 primary or secondary alkane sulfonates, C5-C20 sulfonatedpolycarboxylic acids, and any mixtures thereof, but preferably C11-C13 alkylbenzene sulfonates. The aforementioned surfactants can vary widely in their 2-phenyl isomer content.

The sulfonate anionic surfactant can be linear or branched, with linear being preferred.

### Further Anionic Surfactant

The composition can comprise further anionic surfactant, for instance, to modify the cleaning profile, or improve stability. Suitable further anionic surfactant can be selected from the group consisting of: alkyl sulfate, alkyl carboxylate, alkyl sulfosuccinate, dialkyl sulfosuccinate ester anionic surfactants, and mixtures thereof, with alkyl sulfate anionic surfactants being preferred for improved grease removal. The further anionic surfactant can be present at a level of up to 25% by weight of the anionic surfactant, preferably from 3.0% to 25%, more preferably from 5.0 to 20%, more preferably from 7.5% to 15% by weight of the anionic surfactant.

The anionic surfactant can further comprise alkyl sulfate anionic surfactant. The alkyl sulfate anionic surfactant can have a number average alkyl chain length of from 10 to 18, preferably from 12 to 15 carbon atoms. Anionic sulfate salts suitable for use in the compositions of the invention include the primary and secondary alkyl sulfates, having a linear or branched alkyl or alkenyl moiety. Also useful are beta-branched alkyl sulfate surfactants or mixtures of commercially available materials, having a weight average (of the surfactant or the mixture) branching degree of at least 50%. Linear alkyl sulfates are preferred.

The alkyl sulfate anionic surfactant can be alkoxylated or non-alkoxylated, but are preferably non-alkoxylated. If alkoxylation is present, ethoxylation is preferred. The alkyl sulfate anionic surfactant can have an average degree of alkoxylation of less than 3.0, preferably less than 1.5, more preferably less than 0.5, even more preferably less than 0.1, and most preferably wherein the alkyl sulfate anionic surfactant is free of alkoxylation.

If ethoxylated alkyl sulfate is present, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

Preferred low ethoxylation alkyl sulfate surfactants can comprise branched or linear alkyl sulfate surfactant. The branched alkyl sulfate surfactant can comprise at least 20%, preferably from 60% to 100%, more preferably from 80% to 90% by weight of the alkyl chains of the branched alkyl sulfate surfactant of 2-branched alkyl chains. Such branched alkyl sulfates with 2-branched alkyl chains can also be described as 2-alkyl alkanol sulfates, or 2-alkyl alkyl sulfates. The branched alkyl sulfates can be neutralized by sodium, potassium, magnesium, lithium, calcium, ammonium, or any suitable amines, such as, but not limited to monoethanolamine, triethanolamine and monoisopropanolamine, or by mixtures of any of the neutralizing metals or amines. Suitable branched alkyl sulfate surfactants can comprise alkyl chains comprising from 10 to 18 carbon atoms (C10 to C18) or from 12 to 15 carbon atoms (C12 to C15), with 13 to 15 carbon atoms (C13 to C15) being most preferred. The branched alkyl sulfate surfactant can be produced using processes which comprise a hydroformylation reaction in order to provide the desired levels of 2-branching. Particularly preferred branched alkyl sulfate surfactants comprise 2-branching, wherein the 2-branching comprises from 20% to 80%, preferably from 30% to 70%, more preferably from 40% to 65% by weight of the 2-branching of methyl branching, ethyl branching, and mixtures thereof.

Suitable low ethoxylated branched alkyl sulfate surfactants can be derived from alkyl alcohols such as Lial® 145, Isalchem® 145, both supplied by Sasol, optionally blending with other alkyl alcohols in order to achieve the desired branching distributions.

The surfactant system can comprise less than 3.0%, preferably less than 2.0%, more preferably from 0.5% to 1.5% by weight of the composition of fatty acid.

However, by nature, every anionic surfactant known in the art of detergent compositions may be used, such as disclosed in “Surfactant Science Series”, Vol. 7, edited by W. M. Linfield, Marcel Dekker. Other suitable anionic surfactants for use herein include fatty methyl ester sulfonates and/or alkyl polyalkoxylated carboxylates, for example, alkyl ethoxylated carboxylates (AEC).

The anionic surfactants are typically present in the form of their salts with alkanolamines or alkali metals such as sodium and potassium.

However, by nature, every anionic surfactant known in the art of detergent compositions may be used, such as disclosed in “Surfactant Science Series”, Vol. 7, edited by W. M. Linfield, Marcel Dekker. Other suitable anionic surfactants for use herein include fatty methyl ester sulfonates and/or alkyl polyalkoxylated carboxylates, for example, alkyl ethoxylated carboxylates (AEC).

The anionic surfactants are typically present in the form of their salts with alkanolamines or alkali metals such as sodium and potassium.

Alkyl sulfosuccinate and dialkyl sulfosuccinate esters are organic compounds with the formula MO3SCH(CO2R′)CH2CO2R where R and R′ can be H or alkyl groups, and M is a counter-ion such as sodium (Na). Alkyl sulfosuccinate and dialkyl sulfosuccinate ester surfactants can be alkoxylated or non-alkoxylated, preferably non-alkoxylated. The surfactant system may comprise further anionic surfactant. However, the composition preferably comprises less than 30%, preferably less than 15%, more preferably less than 10% by weight of the surfactant system of further anionic surfactant. Most preferably, the surfactant system comprises no further anionic surfactant, preferably no other anionic surfactant than alkyl sulfate anionic surfactant and the acyl taurate anionic surfactant.

Amphoteric and/or Zwitterionic Surfactant

The surfactant system can comprise amphoteric and/or zwitterionic surfactant at a level of from 0.1% to 2.0%, preferably from 0.1% to 1.0%, more preferably from 0.1% to 0.5% by weight of the liquid laundry detergent composition.

Suitable amphoteric surfactants include amine oxide surfactants. Amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R3 are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide (lauryl dimethylamine oxide), commercially available from Albright & Wilson, C₁₂-C₁₄ amine oxides commercially available under the trade name Genaminox® LA from Clariant or AROMOX® DMC from AKZO Nobel.

Suitable amphoteric or zwitterionic detersive surfactants include those which are known for use in hair care or other personal care cleansing. Non-limiting examples of suitable zwitterionic or amphoteric surfactants are described in U.S. Pat. Nos. 5,104,646, 5,106,609. Suitable amphoteric detersive surfactants include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulfonate, sulfate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

### Nonionic Surfactant

The surfactant system can comprise nonionic surfactant. The level of nonionic surfactant in the liquid detergent composition can be present at a level of less than 5.0%, preferably from 0.5% to 4.0%, more preferably form 1.0% to 3.0% by weight of the composition.

The nonionic surfactant is preferably selected from alkoxylated alkyl alcohol nonionic surfactant, alkyl polyglucoside, and mixtures thereof, more preferably wherein the nonionic surfactant comprises alkyl polyglucoside nonionic surfactant.

Suitable alkoxylated alkyl alcohol nonionic surfactant include C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e.g., amine oxides and phosphine oxides) can be used in the present compositions. An extensive disclosure of these types of surfactants is found in U.S. Pat. No. 3,929,678, Laughlin et al., issued Dec. 30, 1975.

For improved whiteness, the alkyl polyglucoside surfactant can have a number average alkyl carbon chain length from 8 to 16, preferably from 10 to 14, most preferably from 12 to 14, with an average degree of polymerization of from 0.1 to 3.0, preferably from 1.0 to 2.0, most preferably from 1.2 to 1.6.

C8-C18 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

Alkylpolysaccharides such as disclosed in U.S. Pat. No. 4,565,647 Llenado are also useful nonionic surfactants in the compositions of the invention.

### Optional Ingredients

The detergent composition may additionally comprise one or more of the following optional ingredients: dye fixative polymer, external structurant or thickener, enzymes, enzyme stabilizers, cleaning polymers, optical brighteners, hueing dyes, particulate material, perfume and other odour control agents, hydrotropes, suds suppressors, fabric care benefit agents, pH adjusting agents, dye transfer inhibiting agents, preservatives, non-fabric substantive dyes and mixtures thereof.

Suitable dye fixative polymers include vinylpyrrolidone polymers. The vinylpyrrolidone polymer can be selected from the group consisting of: polyvinylpyrrolidone (PVP), copolymers of vinylpyrrolidone and vinylimidazole (PVP/PVI), and mixtures thereof.

The composition can comprise enzymes. Suitable enzymes can be added to provide further cleaning performance and/or fabric care benefits. Examples of suitable enzymes include, but are not limited to, peroxidases, proteases, xylanases, xyloglucanases, pectate lyases, nucleases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, lipase, cutinase with cellulase in conjunction with amylase. Detersive enzymes are described in greater detail in U.S. Pat. No. 6,579,839.

External structurant or thickener: Preferred external structurants and thickeners are those that do not rely on charge-charge interactions for providing a structuring benefit. As such, particularly preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

Suitable polymeric structurants include naturally derived and/or synthetic polymeric structurants.

Examples of naturally derived polymeric structurants of use in the present invention include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO 2009/101545 A1. Suitable polysaccharide derivatives include: pectine, alginate, arabinogalactan (gum Arabic), carrageenan, gellan gum, xanthan gum, guar gum and mixtures thereof.

Examples of synthetic polymeric structurants or thickeners of use in the present invention include: polycarboxylates, hydrophobically modified ethoxylated urethanes (HEUr), hydrophobically modified non-ionic polyols and mixtures thereof.

Preferably, the aqueous liquid detergent composition has a viscosity of 50 to 5,000, preferably 75 to 1,000, more preferably 100 to 500 mPa·s, when measured at a shear rate of 100 s−1, at a temperature of 20° C. For improved phase stability, and also improved stability of suspended ingredients, the aqueous liquid detergent composition has a viscosity of 50 to 250,000, preferably 5,000 to 125,000, more preferably 10,000 to 35,000 mPa·s, when measured at a shear rate of 0.05 s−1, at a temperature of 20° C.

Cleaning polymers: The detergent composition preferably comprises a cleaning polymer. Such cleaning polymers are believed to at least partially lift the stain from the textile fibres and enable the enzyme system to more effectively break up the complexes comprising mannan and other polysaccharide. Suitable cleaning polymers provide for broad-range soil cleaning of surfaces and fabrics and/or suspension of the soils. Non-limiting examples of suitable cleaning polymers include: amphiphilic alkoxylated grease cleaning polymers; clay soil cleaning polymers; soil release polymers; and soil suspending polymers. A preferred cleaning polymer is obtainable by free-radical copolymerization of at least one compound of formula (I),

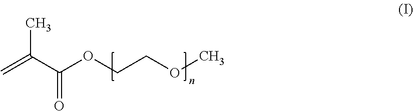

in which n is equal to or greater than 3 for a number,

with at least one compound of formula (II),

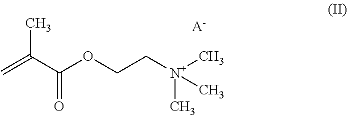

in which A⁻ represents an anion, in particular selected from halides such as fluoride, chloride, bromide, iodide, sulfate, hydrogen sulfate, alkyl sulfate such as methyl sulfate, and mixtures thereof. Such polymers are further described in EP3196283A1.

The composition may further comprise one or more polymers. Examples are: polyethyleneimines, polyester based soil release polymers, optionally modified carboxymethylcellulose, modified polyglucans, poly(vinyl-pyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN260, SRN300 and SRN325 supplied by Clariant. Other suitable soil release polymers are Marloquest polymers, such as Marloquest SL supplied by Sasol.

Other useful cleaning polymers are described in US20090124528A1. The detergent composition may comprise amphiphilic alkoxylated grease cleaning polymers, which may have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkyleneimines, for example. Such compounds may comprise, but are not limited to, ethoxylated polyethyleneimine, ethoxylated hexamethylene diamine, and sulfated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The alkoxylated polyalkyleneimines may have an inner polyethylene oxide block and an outer polypropylene oxide block. The detergent compositions may comprise from 0.1% to 10%, preferably, from 0.1% to 8.0%, more preferably from 0.1% to 2.0%, by weight of the detergent composition, of the cleaning polymer.

Suitable graft polymers are also described in WO2007/138053 as amphiphilic graft polymers based on water-soluble polyalkylene oxides (A) as a graft base and side chains formed by polymerization of a vinyl ester component (B), said polymers having an average of <one graft site per 50 alkylene oxide units and mean molar masses M of from 3 000 to 100 000. One specific preferred graft polymer of this type is polyvinyl acetate grafted polyethylene oxide copolymer having a polyethylene oxide as graft base and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. The most preferred polymer of this type is available from BASF as Sokalan PG101. Suitable graft polymer also include graft polymer comprising a block copolymer backbone (A) as a graft base, wherein said block copolymer backbone (A) is obtainable by polymerization of at least two monomers selected from the group of ethylene oxide, 1,2-propylene oxide, 1,2-butylene oxide, 2,3-butylene oxide, 1,2-pentene oxide or 2,3-pentene oxide, wherein the number (x) of individual blocks within the block copolymer backbone (A) is an integer, wherein x is from 2 to 10 and preferably 3 to 5, and (B) polymeric sidechains grafted onto the block copolymer backbone, wherein said polymeric sidechains (B) are obtainable by polymerization of at least one vinyl ester monomer. Suitable graft polymers of this type are described in WO2021/160795 and WO2021/160851, these polymers have improved biodegradation profiles.

Suitable graft polymers can comprise a polyalkylene oxide backbone (A) which has a number average molecular weight of from about 1000 to about 20,000 Daltons and is based on ethylene oxide, propylene oxide, or butylene oxide; and side chains derived from N-vinylpyrrolidone (B), and side chains derived from vinyl ester (C) derived from a saturated monocarboxylic acid containing from 1 to 6 carbon atoms and/or a methyl or ethyl ester of acrylic or methacrylic acid. Such graft polymers are described in WO2020005476 and can be used as dye transfer inhibitors.

The composition may comprise alkoxylated polyamines. Such materials include but are not limited to ethoxylated polyethyleneimine, ethoxylated hexamethylene diamine, and sulfated versions thereof. Polypropoxylated derivatives are also included. A wide variety of amines and polyaklyeneimines may be alkoxylated to various degrees, and optionally further modified to provide the abovementioned benefits. A useful example is 600 g/mol polyethyleneimine core ethoxylated to 20 EO groups per NH. A preferred ethoxylated polyethyleneimine is PE-20 available from BASF.

Suitable cellulosic polymers are selected from alkyl cellulose, alkyl alkoxyalkyl cellulose, carboxyalkyl cellulose, alkyl carboxyalkyl cellulose, sulfoalkyl cellulose, more preferably selected from carboxymethyl cellulose, methyl cellulose, methyl hydroxyethyl cellulose, methyl carboxymethyl cellulose, and mixtures thereof. Suitable carboxymethyl celluloses have a degree of carboxymethyl substitution from 0.5 to 0.9 and a molecular weight from 100,000 Da to 300,000 Da. Suitable carboxymethyl celluloses have a degree of substitution greater than 0.65 and a degree of blockiness greater than 0.45, e.g. as described in WO09/154933.

Dye transfer inhibiting polymer: The detergent composition can comprise one or more dye transfer inhibiting polymer. When used, suitable dye transfer inhibiting can be selected from the group consisting of polyvinylpyrrolidone (PVP), polyvinylimidazole (PVI), copolymers of vinylpyrrolidone and vinylimidazole (PVP/PVI), polyvinyl pyridine-N-oxide, poly-N-carboxymethyl-4-vinylpyridiumchloride, poly(2-hydroxypropyldimethylammonium chloride), and mixtures thereof, preferably polyvinylpyrrolidone (PVP), polyvinylimidazole (PVI), copolymers of vinylpyrrolidone and vinylimidazole (PVP/PVI), and mixtures thereof. If present, the dye transfer inhibitor can be present at a level of from 0.05% to 5%, or from 0.1% to 3%, and or from 0.2% to 2.5%, by weight of the detergent composition.

Polyvinylpyrrolidone (“PVP”) has an amphiphilic character with a highly polar amide group conferring hydrophilic and polar attracting properties, and also has apolar methylene and methane groups, in the backbone and/or the ring, conferring hydrophobic properties. The rings may also provide planar alignment with the aromatic rings, in the dye molecules. PVP is readily soluble in aqueous and organic solvent systems. PVP is commercially available in either powder or aqueous solutions in several viscosity grades. The compositions of the present invention preferably utilize a copolymer of N-vinylpyrrolidone and N-vinylimidazole (also abbreviated herein as “PVPVI”). It has been found that copolymers of N-vinylpyrrolidone and N-vinylimidazole can provide excellent dye transfer inhibiting performance. The copolymers of N-vinylpyrrolidone and N-vinylimidazole can have a molar ratio of N-vinylimidazole to N-vinylpyrrolidone from 1:1 to 0.2:1, more preferably from 0.8:1 to 0.3:1, most preferably from 0.6:1 to 0.4:1. The copolymer of N-vinylpyrrolidone and N-vinylimidazole can be either linear or branched. Particularly suitable polyvinylpyrrolidones (PVP), polyvinylimidazoles (PVI), and copolymers of vinylpyrrolidone and vinylimidazole (PVP/PVI), can have a weight average molecular weight of from 5,000 Da to 1,000, 000 Da, preferably from 5,000 Da to 50,000 Da, more preferably from 10,000 Da to 20,000 Da. The number average molecular weight range is determined by light scattering as described in Barth J. H. G. and Mays J. W. Chemical Analysis Vol 1 13. “Modern Methods of Polymer Characterization.” Copolymers of poly (N-vinyl-2-pyrollidone) and poly (N-vinyl-imidazole) are commercially available from a number of sources including BASF. A preferred DTI is commercially available under the tradename Sokalan® HP 56 K from BASF (BASF SE, Germany).

Polymer Deposition Aid: The laundry detergent composition can comprise from 0.1% to 7.0%, more preferably from 0.2% to 3.0%, of a polymer deposition aid. As used herein, “polymer deposition aid” refers to any cationic polymer or combination of cationic polymers that significantly enhance deposition of a fabric care benefit agent onto the fabric during laundering. Suitable polymer deposition aids include a cationic polysaccharide and/or a copolymer, with cationic polysaccharide being preferred. The cationic polymer can also be selected from the group consisting of: poly (diallyldimethylammonium chloride/co-acrylic acid), poly(acrylamide-methacrylamidopropyltrimethyl ammonium chloride), poly(acrylamide-methacrylamidopropyltrimethyl ammonium chloride/co-acrylic acid), poly(acrylamide-co-diallyldimethylammonium chloride/co-acrylic acid), poly(acrylamide-co-N,N, N-trimethyl aminoethyl acrylate), poly(diallyldimethylammonium chloride/co-vinyl alcohol), poly (diallyldimethylammonium chloride/acrylamide), and mixtures thereof. The diallyldimethylammonium chloride and co-acrylic acid monomers can be present in a mol ratio of from 50:50 to 90:10, preferably from 55:45 to 85:15, more preferably from 60:40 to 70:30. For poly(diallyldimethylammonium chloride/co-acrylic acid) the preferred ratio of diallyldimethylammonium chloride to acrylic acid is between approximately 90:10 and 50:50. The preferred cationic polymer is poly (diallyldimethylammonium chloride/co-acrylic acid) copolymer at a 65/35 mole ratio with a molecular weight of approximately 450,000. Poly (diallyldimethylammonium chloride/co-acrylic acid) copolymer may be further described by the nomenclature Polyquaternium-22 or PQ22 as named under the International Nomenclature for Cosmetic Ingredients. Poly (diallyldimethylammonium chloride/acrylamide) may be further described by the nomenclature Polyquaternium-7 or PQ7 as named under the International Nomenclature for Cosmetic Ingredients.

“Fabric care benefit agent” as used herein refers to any material that can provide fabric care benefits. Non-limiting examples of fabric care benefit agents include: silicone derivatives, oily sugar derivatives, dispersible polyolefins, polymer latexes, cationic surfactants and combinations thereof. Preferably, the deposition aid is a cationic or amphoteric polymer. The cationic charge density of the polymer preferably ranges from 0.05 milliequivalents/g to 6.0 milliequivalents/g. The charge density is calculated by dividing the number of net charge per repeating unit by the molecular weight of the repeating unit. In one embodiment, the charge density varies from 0.1 milliequivalents/g to 3.0 milliequivalents/g. The positive charges could be on the backbone of the polymers or the side chains of polymers.

Organic builder and/or chelant: The laundry detergent composition can comprise from 0.6% to 10%, preferably from 2.0 to 7.0% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (EDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates such as Tiron™ and mixtures thereof.

Enzyme stabiliser: Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Hueing dyes: The detergent composition may comprise fabric hueing agent (sometimes referred to as shading, bluing, or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes, leuco dyes and combinations thereof.

Optical brighteners: The detergent composition may comprise, based on the total detergent composition weight, from 0.005% to 2.0%, preferably 0.01% to 0.1% of a fluorescent agent (optical brightener). Fluorescent agents are well known and many fluorescent agents are available commercially. Usually, these fluorescent agents are supplied and used in the form of their alkali metal salts, for example, the sodium salts. Preferred classes of fluorescent agent are: Di-styryl biphenyl compounds, e.g. Tinopal® CBS-X, Di-amine stilbene di-sulfonic acid compounds, e.g. Tinopal® DMS pure Xtra and Blankophor® HRH, and Pyrazoline compounds, e.g. Blankophor® SN. Preferred fluorescers are: sodium 2-(4-styryl-3-sulfophenyl)-2H-napthol[1,2-d]trazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]annino}stilbene-2-2′ disulfonate, and disodium 4,4′-bis(2-sulfoslyryl)biphenyl.

Hydrotrope: The detergent composition may comprise, based on the total detergent composition weight, from 0 to 30%, preferably from 0.5 to 5%, more preferably from 1.0 to 3.0%, which can prevent liquid crystal formation. The addition of the hydrotrope thus aids the clarity/transparency of the composition. Suitable hydrotropes comprise but are not limited to urea, salts of benzene sulfonate, toluene sulfonate, xylene sulfonate or cumene sulfonate. Preferably, the hydrotrope is selected from the group consisting of propylene glycol, xylene sulfonate, ethanol, and urea to provide optimum performance.

Particles: The composition can also comprise particles, especially when the composition further comprises a structurant or thickener. The composition may comprise, based on the total composition weight, from 0.02% to 10%, preferably from 0.1% to 4.0%, more preferably from 0.25% to 2.5% of particles. Said particles include beads, pearlescent agents, capsules, and mixtures thereof.

Suitable capsules are typically formed by at least partially, preferably fully, surrounding a benefit agent with a wall material. Preferably, the capsule is a perfume capsule, wherein said benefit agent comprises one or more perfume raw materials. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof. Preferably, the capsule wall comprises melamine and/or a polyacrylate based material. The perfume capsule may be coated with a deposition aid, a cationic polymer, a non-ionic polymer, an anionic polymer, or mixtures thereof. Preferably, the perfume capsules have a volume weighted mean particle size from 0.1 microns to 100 microns, preferably from 0.5 microns to 60 microns. Especially where the composition comprises capsules having a shell formed at least partially from formaldehyde, the composition can additionally comprise one or more formaldehyde scavengers.

### Process of Making the Laundry Detergent Composition

The laundry detergent compositions can be made using any suitable process known to the skilled person. Typically, the ingredients are blended together in any suitable order. Preferably, the detersive surfactants are added as part of a concentrated premix, to which are added the other optional ingredients. Preferably, the solvent is added either last, or if an external structurant is added, immediately before the external structurant, with the external structurant being added as the last ingredient.

### Method of Laundering Fabrics

The laundry detergent compositions of the present invention are used to launder fabrics. In such methods and uses, the laundry detergent composition can be diluted to provide a wash liquor having a total surfactant concentration of greater than 300 ppm, preferably from 400 ppm to 2,500 ppm, more preferably from 600 ppm to 1000 ppm. The fabric is then washed in the wash liquor, and preferably rinsed.

### Methods

### A) pH Measurement:

The pH is measured, at 25° C., using a Santarius PT-10P pH meter with gel-filled probe (such as the Toledo probe, part number 52 000 100), calibrated according to the instruction manual. The pH is measured in a 10% dilution in demineralised water (i.e. 1 part laundry detergent composition and 9 parts demineralised water).

### B) Measuring Viscosity:

The viscosity is measured using an AR 2000 rheometer from TA instruments using a cone and plate geometry with a 40 mm diameter and an angle of 1°. The viscosity at the different shear rates is measured via a logarithmic shear rate sweep from 0.1 s⁻¹ to 1200 s⁻¹ in 3 minutes time at 20° C. Low shear viscosity is measured at a continuous shear rate of 0.05 s⁻¹.

### C) NMR Characterisation:

Standard 13C NMR spectra are typically obtained by dissolving approximately 0.03 to 0.04 g of the alkyl glycol sulfate anionic surfactant of formula (I) in a mixture of 0.6 g of Deuterium Oxide and 0.3 g of Methanol-d4 to form a clear solution. 13C Spectra are obtained using a Bruker 300 MHz NMR with 2048 to 5120 transient scans to achieve good signal to noise ratio.

Chemical shifts are referenced to Methanol-d4 chemical shift set at 49.15 ppm. The resonance peak at approximately 14.85 to 15.00 ppm is assigned to the terminal methyl group of the R2 group of formula (I) being an n-alkyl group and is integrated with value set to 1.00. The resonance peak at approximately 20.10 to 20.20 ppm being assigned to the R1 group of formula (I) being a Methyl group, is integrated and ratioed to the R2 terminal methyl group integration value set at 1.00 to determine the level of the R1 group of formula (I) being Methyl.

### EXAMPLES

### Synthesis Examples

The following blends comprising alkyl glycol sulfate and alkyl sulfate anionic surfactant were prepared as follows:

### Synthesis Example 1: Co-Synthesis of C12 Alkyl Ethylene Glycol Sulfate and C12 Alkyl Sulfate Blend

Co-synthesis of branched C12 alkyloxy ethanol (primarily 2-[(1-methylundecyl)oxy]ethanol (CAS 5940-87-4)) with dodecan-2-ol (CAS 10203-28-8):

To a 2-liter, single neck, round bottom reaction flask was added 50.18 g (0.298 mol) 1-dodecene, 74.08 g (1.19 mol) ethylene glycol, 49.84 g (0.262 mol) p-toluene sulfonic acid monohydrate and a magnetic stir bar. With mixing while venting to the atmosphere, the reaction flask was heated using a silicon oil bath maintained at 130° C. After 2 hours, the reaction mixture was sampled for thin layer chromatography (TLC) analysis. The TLC results indicated product formation as well as the presence of residual starting materials. The reaction flask was removed from the oil bath and allowed to cool to room temperature (21° C.) at which point the reaction product was combined with 1 L aqueous solution of 10 wt % sodium carbonate, then washed three times with 2 L of ethyl acetate in a separatory funnel. The ethyl acetate layers were combined, dried by adding anhydrous sodium sulfate, filtered to remove the sodium sulfate and concentrated by evaporating solvent using rotary evaporator. The product was purified by silica gel column chromatography (80:20 hexane:ethyl acetate mobile phase), with the fractions containing the desired product being combined and concentrated by evaporation of solvent using the rotary evaporator to yield 4.012 g of product. The presence of the desired 2-[(1-methylundecyl)oxy]ethanol and dodecan-2-ol products was confirmed by NMR and MS analysis.

A second synthesis and purification was completed on similar scale using the above procedure to yield 4.672 g of desired product. The two separately synthesized/purified 2-[(1-methylundecyl)oxy]ethanol and dodecan-2-ol blends were combined for subsequent sulfation.

### Co-Sulfation of the Branched C12 Alkyloxy Ethanol and Dodecan-2-ol Blend:

A 1-L, 3-neck, round bottom flask was equipped with a magnetic stir bar, an addition funnel with pressure equalizing arm and nitrogen gas feed in the center neck, a thermometer in one side neck and a tubing vent line in the other side neck leading to a gas bubbler filled with demineralised water to trap HCl gas evolved from reaction. A 2-Liter glass trap was positioned between the gas bubbler and the reaction flask to prevent water being drawn back into the reaction flask. 135.5 grams of the 2-[(1-methylundecyl)oxy]ethanol and dodecan-2-ol blend, and 150 ml of ACS Reagent Grade diethyl ether (EMD Millipore product #EX0190) were added to the round bottom flask. 72.6 grams (0.617 moles) of 99.0% chlorosulfonic acid (Sigma-Aldrich product #571024) was added to the addition funnel. A nitrogen gas flow ran from the top of additional funnel, through the flask and out the side neck vent line to the gas bubbler. An ice/NaCl/water bath was placed around the reaction flask. Mixing was begun, forming a clear, dark orange solution. Once the reaction mixture reached 5° C., the chlorosulfonic acid was dripped in at a rate that controlled the exotherm heat release and maintained the temperature at or below 10° C. The chlorosulfonic acid addition was completed within 60 minutes.

The ice/NaCl/water bath was replaced with a 22° C. water bath. The vent line tube attached to the gas bubbler was switched to a vacuum tube attached to a diaphragm vacuum pump. Solvent traps cooled with a dry ice/isopropanol bath were positioned along the vacuum tube between the reaction flask and the vacuum pump to trap volatiles pulled from the reaction mixture. A dial pressure gauge (from US Gauge reading from 0-30 inches of Hg) was positioned in the vacuum tube after the solvent trap to measure vacuum pulled on system. The reaction continued to mix for 14 minutes under nitrogen gas sweep, while the vacuum system was set up.

With continued mixing, the vacuum pump is turned on to begin applying a vacuum to the reaction mixture. The vacuum level was slowly increased by incrementally decreasing the nitrogen gas flow from the addition funnel. This was done to control foaming of the reaction mixture. Eventually the nitrogen flow was completely stopped resulting in full vacuum applied to the reaction mixture (30 inches of Hg [1.02 bar] measured on the vacuum gauge indicating full vacuum applied). Full vacuum was reached 27 minutes from start of vacuum treatment. Mixing was continued under full vacuum for an additional 26 minutes at which point the reaction mixture was clear, brown in color, fluid with minimal bubbling observed, at which point the vacuum was broken with nitrogen gas flow.

With good vortex mixing using a magnetic stir bar, the reaction mixture was slowly poured into a solution of 144.8 grams (0.676 moles) of 25.2 wt % sodium methoxide in methanol reagent (Sigma-Aldrich product #156256) diluted to a total volume of 1 Liter with ACS Reagent Grade methanol (EMD Millipore product #MX0475) contained in a glass beaker to convert the sulfated 2-[(1-methylundecyl)oxy]ethanol and dodecan-2-ol reaction product from the acid sulfate to the sodium salt. The resulting product was a cloudy mixture with a light brown precipitate with good vortex mixing. Approximately 0.2 grams of this neutralized reaction product was dissolved in approximately 0.5 grams of demineralised water and the pH was measured to be approximately 10-11 using a pH test strip. The resulting product was mixed for an additional 15 minutes, and the pH again measured to be 10-11.

The reaction product was concentrated by evaporating the solvent using a rotary evaporator with a water bath set at 50° C. until mixture began to foam, at with point the mixture was poured into a glass crystallizing dish. The crystallizing dish was placed in a vacuum oven at 21° C. under partial vacuum with a slow nitrogen gas flow through the oven to prevent the product mixture from foaming while further concentrating. Internal pressure of vacuum oven was approximately 4 inches of Hg [0.14 bar]. After 4 days, the concentrated reaction product was removed from the vacuum oven. The product was now a solid. The solid was broken into smaller particles using a spatula then placed into vacuum oven at 27° C. under full vacuum. After 7 hours, the product was ground into smaller particles using a mortar and pestle before being placed into a vacuum oven overnight under full vacuum at 21° C. The next day, product was again ground into smaller particles using a mortar and pestle before being placed back into the vacuum oven under full vacuum at 27° C. for 7 hours and then overnight under full vacuum at 21° C. The next day, the product was sampled for NMR analysis (Proton, Carbon and DEPT) and placed in vacuum oven under full vacuum at 21° C. The next day, the product was ground using a mechanical grinder, then placed into the vacuum oven under full vacuum at 27° C. for 3 hours and then at 21° for 5 days. After 5 days, the product was sampled for proton NMR and standard cationic SO3 titration analysis before being transferred to a bottle for storage. 188.2 g of light brown solid product was obtained.

NMR Analysis: 0.0424 g of the product was dissolved in a mixture of 0.6 g of deuterium oxide+0.3 g of methanol-d4 for NMR analysis (¹H, ¹³C and DEPT). By NMR, the desired target product of 2-[(1-methylundecyl)oxy]ethanol sodium sulfate and 2-dodecanol sodium sulfate was identified.

The NMR resonances for 2-dodecanol sodium sulfate were verified by the synthesis of a reference sample of 2-dodecanol sodium sulfate via the sulfation of 2-dodecanol (Sigma-Aldrich product #D221503) using the standard sulfation procedure described above.

Quantification of the level of C12 alkyl ethylene glycol sulfate and C12 alkyl sulfate in the sulfated product was determined using ¹H NMR. The level of the alkyl ethylene glycol sulfate anionic surfactant was calculated to be 86.5% by weight of the sulfated product, primarily 2-[(1-methylundecyl)oxy]ethanol sodium sulfate (i.e. where R1 is methyl and R2 is n-decyl, determined by ¹³C NMR). The level of 2-dodecanol sulfate anionic surfactant was calculated to be 13.5% by weight of the sulfated product.

The final product was determined to be 89.6% active total sulfated surfactant blend by standard cationic SO3 titration analysis (ASTM International Standard Designation: D3049), on a solids basis. The remaining 10.4% non-surfactant solids balance were impurities such as sodium sulfate, sodium chloride and residual moisture.

### Synthesis Example 2: Co-Synthesis of C14 Alkyl Glycol Sulfate and C14 Alkyl Sulfate Blend

Co-synthesis of branched C14 alkyloxy ethanol (primarily 2-[(1-methyltridecyl)oxy]ethanol (CAS #19494-32-7)) with tetradecan-2-ol (CAS 4706-81-4):

To a 2-liter, single neck, round bottom reaction flask was added 150 g (0.765 mol) 1-tetradecene, 142 g (2.28 mol) ethylene glycol, 138 g (0.726 mol) p-toluene sulfonic acid monohydrate and a magnetic stir bar. With mixing while venting to the atmosphere, the reaction flask was heated using a silicone oil bath maintained at 100° C. After 72 hours, the reaction mixture was sampled for TLC analysis. TLC results indicated product formation as well as the presence of residual starting materials. The reaction flask was removed from the oil bath and allowed to cool to room temperature (21° C.) at which point the reaction product was combined with 2 L aqueous solution of 10 wt % sodium carbonate, then washed three times with 1.5 L of ethyl acetate in a separatory funnel. The ethyl acetate layers were combined, dried by adding anhydrous sodium sulfate, filtered to remove sodium sulfate, then concentrated by evaporating solvent using rotary evaporator. The product was purified by silica gel column chromatography (80:20 hexane:ethyl acetate mobile phase), with the fractions containing the desired product being combined and concentrated by evaporation of solvent using rotary evaporator to yield 16 g of product. The presence of the desired products 2[(1-methyltridecyl)oxy]ethanol and tetradecan-2-ol was confirmed by NMR and MS analysis.

A second synthesis and purification was completed on similar scale using the above procedure to yield 4 g of product. The two separately synthesized/purified 2[(1-methyltridecyl)oxy]ethanol and tetradecan-2-ol blends were combined for subsequent sulfation.

### Co-Sulfation of the Branched C14 Alkyloxy Ethanol and Tetradecan-2-ol Blend:

A 250-ml, 3-neck, round bottom flask was equipped with a magnetic stir bar, an addition funnel with pressure equalizing arm and nitrogen gas feed in the center neck, a thermometer in one side neck and a tubing vent line in the other side neck leading to a gas bubbler filled with demineralised water to trap HCl gas evolved from reaction. A 2-Liter glass trap was positioned between the gas bubbler and the reaction flask to prevent water being drawn back into the reaction flask. 20.702 grams of the 2-[(1-methyltridecyl)oxy]ethanol and tetradecan-2-ol blend, and 85 ml of ACS Reagent Grade diethyl ether (EMD Millipore product #EX0190) were added to the round bottom flask. 9.852 grams (0.0842 moles) of 99.6% chlorosulfonic acid (Sigma-Aldrich product #571024) was added to the addition funnel. A nitrogen gas flow ran from the top of additional funnel, through the flask and out the side neck vent line to the gas bubbler. An ice/NaCl/water bath was placed around the reaction flask. Mixing was begun, forming a clear, pale yellow solution. Once the reaction mixture reached 7° C., the chlorosulfonic acid was dripped in at a rate that controlled the exotherm heat release and maintained the temperature at or below 10° C. The chlorosulfonic acid addition was completed within 16 minutes.

The ice/NaCl/water bath was replaced with a 22° C. water bath. The vent line tube attached to the gas bubbler was switched to a vacuum tube attached to a diaphragm vacuum pump. Solvent traps cooled with a dry ice/isopropanol bath were positioned along the vacuum tube between the reaction flask and the vacuum pump to trap volatiles pulled from the reaction mixture. A dial pressure gauge (from US Gauge reading from 0-30 inches of Hg) was positioned in the vacuum tube after the solvent trap to measure vacuum pulled on system. The reaction continued to mix for 14 minutes under nitrogen gas sweep, while the vacuum system was set up.

With continued mixing, the vacuum pump is turned on to begin applying a vacuum to the reaction mixture. The vacuum level was slowly increased by incrementally decreasing the nitrogen gas flow from the addition funnel. This was done to control foaming of the reaction mixture. Eventually the nitrogen flow was completely stopped resulting in full vacuum applied to the reaction mixture (30 inches of Hg [1.02 bar] measured on the vacuum gauge indicating full vacuum applied). Full vacuum was reached 24 minutes from start of vacuum treatment. Mixing was continued under full vacuum for an additional 11 minutes at which point the reaction mixture was clear, dark orange in color, fluid with minimal bubbling observed, at which point the vacuum was broken with nitrogen gas flow.

With good vortex mixing using a magnetic stir bar, the reaction mixture was slowly poured into a solution of 19.764 grams (0.0922 moles) of 25.2 wt % sodium methoxide in methanol reagent (Sigma-Aldrich product #156256) diluted with 85 ml of ACS Reagent Grade methanol (EMD Millipore product #MX0475) contained in a 500-ml, single neck, round bottom flask to convert the sulfated 2-[(1-methyltridecyl)oxy]ethanol and tetradecan-2-ol reaction product from the acid sulfate to the sodium salt. The resulting product was a cloudy mixture with a white precipitate with good vortex mixing. Approximately 0.2 grams of this neutralized reaction product was dissolved in approximately 0.5 grams of demineralised water and the pH was measured to be approximately 10 using a pH test strip. The resulting product was mixed for an additional 15 minutes, and the pH again measured to be 10.

The reaction product was concentrated by evaporating the solvent using a rotary evaporator with a water bath set at 50° C. to obtain a soft, yellow solid. The product was placed in a vacuum oven at approximately 27° C. under full vacuum for 1 hour, then allowed to go overnight under full vacuum at 21° C. The next day, the product was broken into smaller particles using a spatula then placed into vacuum oven at 27° C. under full vacuum. After 7 hours, the product was ground into smaller particles using a mortar and pestle before being placed into a vacuum oven overnight under full vacuum at 21° C. The next day, product was sampled for NMR analysis then placed back into the vacuum oven under full vacuum at 21° C. for 3 additional days before being transferred to a bottle for storage. 27.5 g of light brown solid product was obtained.

NMR Analysis: 0.0360 g of the product was dissolved in a mixture of 0.6 g of deuterium oxide+0.3 g of methanol-d4 for NMR analysis (¹H, ¹³C and DEPT). By NMR, the desired target product of 2-[(1-methyltridecyl)oxy]ethanol sodium sulfate and 2-tetradecanol sodium sulfate was identified.

Quantification of the level of C14 alkyl ethylene glycol sulfate and C14 alkyl sulfate in the sulfated product was determined using ¹H NMR. The level of the alkyl glycol sulfate anionic surfactant was calculated to be 94.8% by weight of the sulfated product, primarily 2-[(1-methyltridecyl)oxy]ethanol sodium sulfate (i.e. where R1 is methyl and R2 is n-dodecyl, determined by ¹³C NMR). The level of 2-tetradecanol sulfate anionic surfactant was calculated to be 5.2% by weight of the sulfated product.

The final product was determined to be 90.33% active total sulfated surfactant blend by standard cationic SO3 titration analysis (ASTM International Standard Designation: D3049), on a solids basis. The remaining 9.67% non-surfactant solids balance were impurities such as sodium sulfate, sodium chloride and residual moisture.

### Synthesis Example 3: Co-Synthesis of C16 Alkyl Glycol Sulfate and C16 Alkyl Sulfate Blend

Co-synthesis of branched C14 alkyloxy ethanol (primarily 2-[(1-methylpentadecyl)oxy]ethanol (CAS #30714-96-6)) with hexadecan-2-ol (CAS 14852-31-4):

To a 2-liter, single neck, round bottom reaction flask was added 100.73 g (0.453 mol) 1-hexadecene, 112.81 g (1.82 mol) ethylene glycol, 77.80 g (0.409 mol) p-toluene sulfonic acid monohydrate and a magnetic stir bar. With mixing while venting to the atmosphere, the reaction flask was heated using a silicone oil bath maintained at 130° C. After 7 hours, the reaction mixture was sampled for TLC analysis. TLC results indicated product formation as well as the presence of residual starting materials. The reaction flask was removed from the oil bath and allowed to cool to room temperature (21° C.) at which point the reaction product was combined with 2 L aqueous solution of 10 wt % sodium carbonate, then washed three times with 1.5 L of ethyl acetate in a separatory funnel. The ethyl acetate layers were combined, dried by adding anhydrous sodium sulfate, filtered to remove sodium sulfate, then concentrated by evaporating solvent using rotary evaporator. The product was purified by silica gel column chromatography (80:20 hexane:ethyl acetate mobile phase), with the fractions containing the desired product being combined and concentrated by evaporation of solvent using rotary evaporator to yield 3.91 g of product. The presence of the desired products 2-[(1-methylpentadecyl)oxy]ethanol and hexadecan-2-ol was confirmed by NMR and MS analysis.

A second synthesis and purification was completed on similar scale using the above procedure to yield 4.51 g of product. The two separately synthesized/purified 2-[(1-methylpentadecyl)oxy]ethanol and hexadecan-2-ol blends were combined for subsequent sulfation.

### Co-Sulfation of the Branched C16 Alkyloxy Ethanol and Hexadecan-2-ol Blend:

Sulfation and neutralization were completed using the same procedure as before.

Quantification of the level of C16 alkyl ethylene glycol sulfate and C16 alkyl sulfate in the sulfated product was determined using ¹H NMR. The level of the alkyl ether sulfate anionic surfactant was calculated to be 83.6% by weight of the sulfated product, primarily 2-[(1-methylpentadecyl)oxy]ethanol sodium sulfate (i.e. where R1 is methyl and R2 is n-tetradecyl, determined by ¹³C NMR). The level of 2-hexadecanol sulfate anionic surfactant was calculated to be 16.4% by weight of the sulfated product.

The final product was determined to be 87.5% active total sulfated surfactant blend by standard cationic SO3 titration analysis (ASTM International Standard Designation: D3049), on a solids basis. The remaining 12.5% non-surfactant solids balance were impurities such as sodium sulfate, sodium chloride and residual moisture.

Evaluation of Cleaning Performance, Especially Against Sebum Stains, when Laundering Using Inventive and Comparative Fabric Detergent Compositions

The following wash liquors were prepared to provide a representative comparison of evaluating cleaning efficacy of inventive and comparative fabric detergent compositions against sebum stains and sebum stains which additionally comprised particulate dust. To be more representative of typical laundering conditions, additional stains were also incorporated into the laundering process, as described below. Unless otherwise stated, the alkyl glycol sulfate and alkyl sulfate anionic surfactants used in the comparative test were as produced in the synthesis examples above.

The method involves the use of a tergotometer to simulate the washing of fabrics in a washing machine. Test formulations were used to wash stained swatches, whereby the stained swatches comprised sebum stains (ASTM Dust Sebum on PC-S-94 polycotton fabric and Discriminating Sebum on PC-S-132 polycotton fabric; supplied by Test Fabrics, Inc., West Pittston, Pennsylvania, USA, 2 grams of stained sebum swatches per load) as well as other stains on CW120 cotton fabrics (supplied by Accurate Product Development, Cincinnati, OH, USA, 7 grams of stained swatches per load) to be representative of a typical wash load. Additional swatches comprising background soil were also added to the wash (4 grams of background soil swatches per load, sold by wfk-Testgewebe GmbH, Bruggen, Germany under the name WFK Soil Ballast Load version 2004 (SBL2004), item number 2814003.

One liter (1 L) of wash solutions containing the requisite surfactant ppm (see table below), 100 ppm of 2:1 Ca:Mg hardness, soiled test fabrics, and clean fabric ballast were agitated at 22° C. and 250 rpm for 30 minutes and spun dry. Fabrics were then rinsed in a wash solution containing 100 ppm of 2:1 Ca:Mg hardness at 20° C. for five minutes and spun dry. After the rinse, fabrics were machine dried for 40 minutes before being analysed.

Image analysis was used to compare each stain to an unstained fabric control. Software converted images taken into standard colorimetric values which were calibrated to standards based on the commonly used Macbeth Color Rendition Chart, assigning each stain a colorimetric value (Stain Level). 2 internal replicates and 4 external replicates of each were prepared.

Stain removal index from the swatches was measured as follows:

$$Stain Removal Index = \frac{Δ {E}_{initial} - Δ {E}_{washed}}{Δ {E}_{initial}} \times 100$$

ΔEᵢₙᵢₜᵢₐₗ=Stain level before washing
ΔE_{washed}=Stain level after washing

Stain removal index scores for each stain were calculated and are listed in the table below.

TABLE 1a
Inventive and comparative wash liquors, and the sebum cleaning
efficacy after laundering fabrics with the wash liquors

| | Ex 1 | Ex 2 | Ex A | Ex B |
|---|---|---|---|---|
| | ppm | ppm | ppm | ppm |
| C10-C13 linear alkyl benzene sulfonate¹ | 128 | 128 | 128 | 128 |
| C14 alkyl ethylene glycol sulfate | 14 | 0 | 27 | 0 |
| C16 alkyl ethylene glycol sulfate | 13 | 27 | 0 | 0 |
| C14 alkyl sulfate | 2 | 0 | 5 | 0 |
| C16 alkyl sulfate | 3 | 5 | 0 | 0 |
| C12-C14 linear alkyl sulfate² | 0 | 0 | 0 | 32 |
| C24 EO7 nonionic surfactant³ | 40 | 40 | 40 | 40 |
| Propylene glycol | 40 | 40 | 40 | 40 |
| Ethanol | 16 | 16 | 16 | 16 |
| Citric acid | 40 | 40 | 40 | 40 |
| Sebum stain removal efficacy: | | | | |
| Sebum/dust, based on ASTM D4265-98, on | 39.5 | 40.1 | 38.2 | 33.6 |
| 65/35 polyester/cotton⁴ | | | | |
| High discriminative sebum BEY, pigment, | 29.5 | 29.1 | 28.1 | 24.5 |
| on polyester⁵ | | | | |

¹CALSOFT ® LAS-99, supplied by Pilot Chemical Company
²STEPANOL ® WA-EXTRA-HP, supplied by Stepan Company
³SURFONIC ® L24-7, supplied by Indorama Ventures
⁴CFT PC-S-94, sold by Testfabrics, Inc., 415 Delaware Ave, West Pittston PA 18643 USA
⁵CFT PC-S-132, sold by Testfabrics, Inc., 415 Delaware Ave, West Pittston PA 18643 USA

The above wash liquors are equivalent to preparing wash liquors using the following liquid detergent compositions, as described in table 1b.

TABLE 1b
Inventive and comparative compositions

| | Ex 1 | Ex 2 | Ex A | Ex B |
|---|---|---|---|---|
| | wt % | wt % | wt % | wt % |
| C10-C13 linear alkyl benzene sulfonate¹ | 18.20 | 18.20 | 18.20 | 18.20 |
| C14 alkyl ethylene glycol sulfate | 1.99 | 0.00 | 3.84 | 0.00 |
| C16 alkyl ethylene glycol sulfate | 1.85 | 3.84 | 0.00 | 0.00 |
| C14 alkyl sulfate | 0.28 | 0.00 | 0.71 | 0.00 |
| C16 alkyl sulfate | 0.43 | 0.71 | 0.00 | 0.00 |
| C12-C14 linear alkyl sulfate² | 0.00 | 0.00 | 0.00 | 4.55 |
| C24 EO7 nonionic surfactant³ | 5.69 | 5.69 | 5.69 | 5.69 |
| Propylene glycol | 5.69 | 5.69 | 5.69 | 5.69 |
| Ethanol | 2.28 | 2.28 | 2.28 | 2.28 |
| Citric acid | 5.69 | 5.69 | 5.69 | 5.69 |

Comparing the results from laundering examples 1 and 2 with that from example A show that laundering fabrics using a detergent composition comprising alkyl glycol sulfate anionic surfactant, having an alkyl chain length distribution of use in compositions of the present invention, result in improved removal of sebum stains from fabrics treated using alkyl glycol sulfate anionic surfactant comprising alkyl chains having 14 carbon atoms, in addition to improved removal of other stains, while also providing reduced 1,4-dioxane levels. Comparing the results from laundering examples 1 and 2 with that from example B shows that the benefit is even greater in comparison to compositions formulated using alkyl sulfate anionic surfactant instead of the alkyl glycol sulfate anionic surfactant. The comparative test also demonstrates that the sebum stain removal benefit is also present when the surfactant system of the composition comprises relatively low levels of alkyl glycol sulfate anionic surfactant and high levels of sulfonate anionic surfactant. The comparative data also shows that the benefit is present when the surfactant system comprises further anionic surfactant in addition to the sulfonate anionic surfactant and alkyl diol anionic surfactant.

TABLE 2a
Inventive and comparative wash liquors, and the sebum cleaning
efficacy after laundering fabrics with the wash liquors

| | Ex 3 | Ex 4 | Ex C | Ex D |
|---|---|---|---|---|
| | ppm | ppm | ppm | ppm |
| C10-C13 linear alkyl benzene sulfonate¹ | 32 | 32 | 32 | 32 |
| C14 alkyl ethylene glycol sulfate | 54 | 0 | 109 | 0 |
| C16 alkyl ethylene glycol sulfate | 54 | 107 | 0 | 0 |
| C14 alkyl sulfate | 10 | 0 | 19 | 0 |
| C16 alkyl sulfate | 10 | 21 | 0 | 0 |
| C12-C14 linear alkyl sulfate² | 0 | 0 | 0 | 128 |
| C24 EO7 nonionic surfactant³ | 40 | 40 | 40 | 40 |
| Propylene glycol | 40 | 40 | 40 | 40 |
| Ethanol | 16 | 16 | 16 | 16 |
| Citric acid | 40 | 40 | 40 | 40 |
| Sebum stain removal efficacy: | | | | |
| Sebum/dust, based on ASTM D4265-98, on | 43.7 | 43.2 | 41.8 | 8.5 |
| 65/35 polyester/cotton⁴ | | | | |
| High discriminative sebum BEY, pigment, | 36.9 | 35.3 | 37.2 | 14.0 |
| on polyester⁵ | | | | |

The above wash liquors are equivalent to preparing wash liquors using the following liquid detergent compositions, as described in table 2b.

TABLE 2b
Inventive and comparative compositions

| | Ex 3 | Ex 4 | Ex C | Ex D |
|---|---|---|---|---|
| | ppm | ppm | ppm | ppm |
| C10-C13 linear alkyl benzene sulfonate¹ | 4.55 | 4.55 | 4.55 | 4.55 |
| C14 alkyl ethylene glycol sulfate | 7.68 | 0.00 | 15.50 | 0.00 |
| C16 alkyl ethylene glycol sulfate | 7.68 | 15.22 | 0.00 | 0.00 |
| C14 alkyl sulfate | 1.42 | 0.00 | 2.70 | 0.00 |
| C16 alkyl sulfate | 1.42 | 2.99 | 0.00 | 0.00 |
| C12-C14 linear alkyl sulfate² | 0.00 | 0.00 | 0.00 | 18.20 |
| C24 EO7 nonionic surfactant³ | 5.69 | 5.69 | 5.69 | 5.69 |
| Propylene glycol | 5.69 | 5.69 | 5.69 | 5.69 |
| Ethanol | 2.28 | 2.28 | 2.28 | 2.28 |
| Citric acid | 5.69 | 5.69 | 5.69 | 5.69 |

The results from examples 3 and 4, in comparison to the results of example A show that increasing the proportion of the alkyl glycol sulfate anionic surfactant in the surfactant system results in a further improvement in sebum stain removal. In contrast, from the results of comparative example D to B, raising the proportion of the alkyl sulfate anionic surfactant in compositions where the anionic surfactant is made up of sulfonate and non-alkoxylated alkyl sulfate anionic surfactant does not result in an improvement in sebum removal. Comparing the results from examples 3 and 4 to the results from comparative example C shows that the benefit of formulation the composition using alkyl glycol sulfate, having an alkyl chain length distribution of use in compositions of the present invention, also improves sebum removal for compositions in which the alkyl glycol sulfate forms the bulk of the anionic surfactant used.

The above data also demonstrates that the improvement in sebum removal is also present where the anionic surfactant comprises small amounts of further anionic surfactant (non-ethoxylated alkyl sulfate anionic surfactant in the present examples).

The following are examples of liquid laundry detergent compositions of the present invention.

TABLE 3
Examples of liquid laundry compositions of the present invention

| | Ex 5 | Ex 6 | Ex 7 | Ex 8 |
|---|---|---|---|---|
| Active in formula | wt % | wt % | wt % | wt % |
| C11-C13 alkylbenzene sulfonate | 10.7 | 4.0 | 12 | 13 |
| C12 alkyl ethylene glycol sulfate | — | 2.0 | 0.3 | — |
| C14 alkyl ethylene glycol sulfate | 1.4 | 5.2 | 1.6 | 3.0 |
| C16 alkyl ethylene glycol sulfate | 0.7 | 4.8 | 0.2 | 2.0 |
| C18 alkyl ethylene glycol sulfate | 0 | — | 0.1 | — |
| C12-C16 linear alkyl sulfate | 3.4 | — | — | 0.75 |
| C12-C15 branched alkyl sulfate | 1.7 | 2.0 | — | — |
| Ethoxylated nonionic surfactant⁶ | 12 | 6.0 | — | 4.0 |
| Coconut Fatty acid | 0.6 | 0.6 | 2.1 | 0.65 |
| C12-C14 alkyl dimethyl amine oxide | 0.4 | 0.7 | — | — |
| Glutamic acid diacetate (GLDA) | 0.3 | 0.6 | — | 0.2 |
| Citric acid | 0.7 | 2.1 | 2.6 | 1.2 |
| Whitezyme⁷ | 0.003 | 0.003 | 0.003 | 0.003 |
| Protease⁸ | 0.08 | 0.08 | 0.08 | 0.08 |
| Mannanase⁹ | 0.001 | 0.001 | 0.001 | 0.001 |
| Amylase¹⁰ | 0.013 | 0.013 | 0.013 | 0.013 |
| Ethoxylated polyethyleneimine¹¹ | 0.6 | 0.6 | — | 0.7 |
| Alkoxylated polyethyleneimine¹² | 1.5 | 1.5 | — | — |
| Zwitterionic alkoxylated polyamine ¹³ | — | — | 0.55 | — |
| PEG-PVAc Polymer¹⁴ | — | — | 1.0 | 0.1 |
| DTPMP¹⁵ | — | — | 0.8 | 0.12 |
| Brightener¹⁶ | — | — | 0.05 | — |
| Hueing dye¹⁷ | 0.025 | 0.025 | 0.02 | — |
| Perfume | 0.6 | 1.0 | 1.4 | 0.6 |
| Hydrogenated castor oil | 0.1 | 0.2 | 0.25 | — |
| Ethanol | 1.7 | 1.5 | 0.6 | 1.2 |
| 1,2-propanediol | 1.6 | 2.1 | 1.0 | 0.9 |
| Glycerine | — | — | 0.1 | 0.3 |
| Monoethanolamine | 2.6 | 2.9 | 0.2 | 2 |
| Water & minor | Up to 100 | Up to 100 | Up to 100 | Up to 100 |
| pH (using NaOH) | to pH 8 | 8 | 8 | 8 |
| Reco Dose | 50 mls | 50 mls | 50 mls | 50 mls |

⁶Surfonic L24-9 commercially available from Huntsman and/or Neodol 45-7 commercially available from Shell Chemicals
⁷Whitezyme 2.0 (WZ) commercially available from Novozyme
⁸Protease commercially available from IFF
⁹Mannanase commercially available from Novozymes
¹⁰Amylase commercially available from Novozymes
¹¹600 g/mol polyethyleneimine core ethoxylated to 20 EO groups per NH and is available from BASF
¹²600 g/mol polyethyleneimine core ethoxylated to 24 EO groups and propoxylated to 16 PO groups per NH and is available from BASF
¹³ Trans-sulphated ethoxylated hexamethylene diamine quaternary zwitterionic, supplied by BASF
¹⁴Polyvinyl acetate grafted polyethylene oxide copolymer having a polyethylene oxide backbone and multiple polyvinyl acetate side chains, supplied by BASF, Germany
¹⁵Diethylenetriamine penta(methylene phosphonic acid) (DTPMP)
¹⁶Disodium 4,4′-bis{[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt
¹⁷Polymeric dyes such as described in WO2011/98355, US 2012/225803 Al, US 2012/090102 Al, U.S. Pat. No. 7,686,892 B2, and WO2010/142503, WO2011/045195, WO2010/148624, WO2010/102861, WO2011/098355, WO2012/163871, WO2012/26665, WO2012/119859 and WO2011/047987

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising from about 2.5% to about 60% by weight of the detergent composition of a surfactant system, wherein the surfactant system comprises: anionic surfactant, wherein the anionic surfactant comprises sulfonate anionic surfactant and an alkyl glycol sulfate anionic surfactant, wherein alkyl glycol sulfate anionic surfactant has the formula (I): 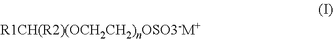
wherein:
R1 is independently H, alkyl, alkylene, or a mixture thereof;
R2 is independently alkyl, alkylene, or a mixture thereof;
the sum of the carbon atoms present in R1 and R2 is on average from 7 to 17;
n is from about 1 to about 3, wherein about 90 mol % or greater of the surfactant molecules of structure (I) have an n of about 1 and about 10 mol % or less of the surfactant molecules of structure (I) have an n of about 2 or greater; and
M+ is a counterion,
characterized in that:
the weight ratio of the alkyl glycol sulfate anionic surfactant of formula (I) in which sum of the carbon atoms present in R1 and R2 is 15 or higher to the total alkyl glycol sulfate anionic surfactant of formula (I) is about 25% or higher.

2. The liquid laundry detergent composition according to claim 1, wherein the weight ratio of alkyl glycol sulfate anionic surfactant of formula (I) in which sum of the carbon atoms present in R1 and R2 is 15 or higher to the total alkyl glycol sulfate anionic surfactant of formula (I) is from about 30% or higher.

3. The liquid laundry detergent composition according to claim 2, wherein the weight ratio of alkyl glycol sulfate anionic surfactant of formula (I) in which sum of the carbon atoms present in R1 and R2 is 15 or higher to the total alkyl glycol sulfate anionic surfactant of formula (I) is from about 30% to 90%.

4. The liquid laundry detergent composition according to claim 1, wherein in the alkyl glycol sulfate anionic surfactant of formula (I), R1 comprises from 1 to 6 carbon atoms.

5. The liquid laundry detergent composition according to claim 4, wherein in the alkyl glycol sulfate anionic surfactant of formula (I), R1 comprises from 1 to 3 carbon atoms.

6. The liquid laundry detergent composition according to claim 1, wherein in at least about 80% by mol of the alkyl glycol sulfate anionic surfactant of formula (I), R1 comprises 1 carbon atom.

7. The liquid laundry detergent composition according to claim 6, wherein in at least about 90% by mol of the alkyl glycol sulfate anionic surfactant of formula (I), R1 comprises 1 carbon atom.

8. The liquid laundry detergent composition according to claim 7, wherein the carbon atom is methyl.

9. The liquid laundry detergent composition according to claim 1, wherein in at least about 50% by weight of the alkyl glycol sulfate of formula (I), R1 is alkyl, with the remainder being H.

10. The liquid laundry detergent composition according to claim 1, wherein in the alkyl glycol sulfate anionic surfactant of formula (I), R2 comprises from 6 to 18 carbon atoms.

11. The liquid laundry detergent composition according to claim 1, wherein in the alkyl glycol sulfate anionic surfactant of formula (I), the sum of the carbon atoms present in R1 and R2 is on average from 7 to 21.

12. The liquid laundry detergent composition according to claim 1, wherein in the alkyl glycol sulfate anionic surfactant of formula (I), about 90 mol % or greater of the surfactant molecules of structure (I) have an n of about 1 and about 10 mol % or less of the surfactant molecules of structure (I) have an n of about 2 or greater.

13. The liquid laundry detergent composition according to claim 1, wherein:
a) the surfactant system at a level of from about 2.5% to about 60% by weight of the composition; and
b) the surfactant system comprises anionic surfactant at a level of from about 2.0% to about 50% of the liquid laundry detergent composition.

14. The liquid laundry detergent composition according to claim 1, wherein:
a) the alkyl glycol sulfate anionic surfactant is present at a level of from about 1.0% to about 15%; and
b) the sulfonate anionic surfactant is present at a level of from about 2.5% to about 30% by weight of the composition.

15. The liquid laundry detergent composition according to claim 1, wherein:
a) the alkyl glycol sulfate anionic surfactant is present at a level of from about 10.0% to about 50% by weight of the anionic surfactant system; and
b) the sulfonate anionic surfactant is present at a level of from about 50.0% to about 90% by weight of the anionic surfactant system;
wherein the total anionic surfactant adds up to 100%.

16. The liquid laundry detergent composition according to claim 1, wherein the sulfonate anionic surfactant is selected form the group consisting of: alkyl benzene sulfonates, alkyl ester sulfonates, paraffin sulfonates, alkyl sulfonated polycarboxylic acids, and mixtures thereof.

17. The liquid laundry detergent composition according to claim 16, wherein the sulfonate anionic surfactant is C11-C13 linear alkyl benzene sulfonate.

18. The liquid laundry detergent composition according to claim 1, wherein the anionic surfactant comprises further anionic surfactant, wherein the further anionic surfactant is selected from the group consisting of: alkyl sulfate, alkyl carboxylate, alkyl sulfosuccinate, dialkyl sulfosuccinate ester anionic surfactants, and mixtures thereof.

19. The liquid laundry detergent composition according to claim 15, wherein the further anionic surfactant is present at a level of up to about 25% by weight of the anionic surfactant by weight of the anionic surfactant.

20. A method of laundering fabrics, the method comprising the steps of:
a) providing a liquid laundry detergent composition according to claim 1;
b) diluting the laundry detergent composition to provide a wash liquor; and
c) washing fabric in the wash liquor.
